(19) United States
(12) Patent Application Publication
(10) Pub. No.: US 2014/0278543 A1
(43) Pub. Date: Sep. 18, 2014

(54) DATA COLLECTION MARKETPLACE FOR A DATA REGISTRY SYSTEM

(71) Applicant: M2S, Inc., West Lebanon, NH (US)

(72) Inventor: Samuel B. Kasdon, West Roxbury, MA (US)

(73) Assignee: M2S, Inc., West Lebanon, NH (US)

(21) Appl. No.: 14/200,908

(22) Filed: Mar. 7, 2014

Related U.S. Application Data
(60) Provisional application No. 61/783,646, filed on Mar. 14, 2013.

(51) Int. Cl. G06F 19/00

(52) U.S. Cl. CPC G06F 19/322
USPC 705/3

(57) ABSTRACT

In one aspect of the disclosed technology, the system includes a data collection marketplace. In some implementations, marketplace users may request publication of a data collection to the data collection marketplace. Registry users may browse the data collection marketplace and subscribe to a data collection request. In certain embodiments, patient data collected by a registry user is provided to the data collection marketplace. The patient data responsive to data collection requests, in certain embodiments, is made available to the marketplace users that published these data collection requests. Marketplace users may use the data for a variety of purposes, including clinical studies and market research.

### RELATED APPLICATIONS

This application claim priority to U.S. Provisional Patent Application No. 61/783,646, filed on Mar. 14, 2013, entitled Data Collection Marketplace for a Data Registry System, the content of which is hereby incorporated by reference in its entirety.

### BACKGROUND

Currently, hospitals and other medical institutions have medical databases that can store patient identification information and medical information. However, many of these database systems are proprietary to the particular medical institution and cannot communicate with the database systems of other medical institutions. In addition, many of these systems may only be used to retrieve data regarding a particular patient. Thus, there is a need for more robust systems for communication of information between and among medical databases and medical institutions.

### SUMMARY

The disclosed technology, in certain embodiments, relates generally to a method and system for collecting, storing, and analyzing clinical and radiologic data. The system, in certain embodiments, includes a database storing patient data from a plurality of sites and a registry processor. Each of the plurality of sites may store their data segregated from the remainder of the sites, or may “pool” their data with other sites. Each group of sites pooling data is termed a “registry group”. A site may belong to one, a plurality, or no registry groups.

In another aspect of the disclosed, a data registry provides real-time data access to patient data for clinicians, hospitals, etc. In certain embodiments, different medical providers may share clinical and/or aggregated data so that they may, for example, evaluate the efficacy of different treatment protocols, how well a particular medical institution is doing as compared to others, and/or the recovery rate of patients of a particular surgeon. These comparisons provide medical institutions with information regarding the areas in which they are doing well, and the ability to recognize where they need improvement. This data is useful in order to improve the quality of patient care.

In another aspect of the disclosed technology, a data registry that provides users the ability to customize data fields so that the users still feel that they have “control” of their data. In certain embodiments, the data registry provides users the ability to generate and run customized queries on the data.

In another aspect of the disclosed technology, the system includes a data collection marketplace. In some implementations, marketplace users may request publication of a data collection to the data collection marketplace. Registry users may browse the data collection marketplace and subscribe to a data collection request. In certain embodiments, patient data collected by a registry user is provided to the data collection marketplace. In certain embodiments, patient data uploaded to the system may be culled to identify patient data responsive to the data collection requests to which the registry user uploading the patient record subscribes. The patient data responsive to these data collection requests, in certain embodiments, is made available to the marketplace users that published these data collection requests. In certain embodiments, marketplace users may download data, provided by registry users that subscribe to their requests, that is responsive to their data collection requests. Marketplace users may use the data for a variety of purposes, including clinical studies and market research.

The disclosed technology, in certain embodiments, includes a processor and a memory storing instructions thereon wherein the instructions, when executed, cause the processor to: provide, to one or more registry users, access to a data collection marketplace, wherein: (i) the data collection marketplace includes one or more data collections associated with one or more marketplace users, (ii) each of the one or more data collections include one or more data fields identifying types of patient data for collection by each of one or more registry users that subscribe to each of the one or more data collections, and (iii) each of the one or more registry users may view the one or more data collections in the data collection marketplace; receive, from a registry user, a request for a subscription to a data collection of the one or more data collections, wherein the registry user has a standard data collection form that includes data fields that are collected by the registry user when the registry user collects patient data; responsive to subscribing to the data collection, append, to the data collection form of the registry user, one or more data fields associated with the data collection, receive, from the registry user, via a network, a patient record, wherein the patient record includes one or more data values associated with one or more data fields of the data collection; and provide, to one or more marketplace users associated with the data collection, via the data collection marketplace, access to one or more data values of the patient record associated with the one or more data fields of the data collection.

In certain embodiments, the disclosed technology includes a method which includes providing, by a processor of a computing device, to one or more registry users, access to a data collection marketplace, wherein: (i) the data collection marketplace includes one or more data collections associated with one or more marketplace users, (ii) each of the one or more data collections include one or more data fields identifying types of patient data for collection by each of one or more registry users that subscribe to each of the one or more data collections, and (iii) each of the one or more registry users may view the one or more data collections in the data collection marketplace; receiving, by the processor, from a registry user, a request for a subscription to a data collection of the one or more data collections, wherein the registry user has a standard data collection form that includes data fields that are collected by the registry user when the registry user collects patient data; responsive to subscribing to the data collection, appending, by the processor, to the data collection form of the registry user, one or more data fields associated with the data collection, receiving, from the registry user, via a network, a patient record, wherein the patient record includes one or more data values associated with one or more data fields of the data collection; and providing, by the processor, to one or more marketplace users associated with the data collection, via the data collection marketplace, access to one or more data values of the patient record associated with the one or more data fields of the data collection. In certain embodiments, the method includes culling, prior to providing access to one or more data values of the patient record, the one or more data values of the patient record to identify the one or more data values associated with one or more data fields of the data collection.

In certain embodiments, the method includes receiving, via a network, from a marketplace user, a request for data collection; storing the request for data collection in one or more databases; and providing the requested data collection in the data collection marketplace.

In certain embodiments, the request for data collection includes a description of the data collection effort and a list of the number and/or type of data elements associated with the data collection.

In certain embodiments, the method includes storing the patient record, received from the registry user, in one or more registry databases, wherein the one or more registry databases store patient data from a plurality of registry users according to a protocol specification.

In certain embodiments, each of the one or more data collections includes one or more subscription criteria. In certain embodiments, the method includes determining, prior to appending, the registry user satisfies the subscription criteria associated with the data collection. In certain embodiments, the registry user receives an incentive upon subscribing to the data collection.

In certain embodiments, the one or more data fields includes patient medical condition information field, pre-operative information field, post-operative information field, procedure type field, operation information field, anesthesia information field, provider information field, patient health field, patient demographic information fields, and/or hospital information field.

In certain embodiments, the patient record includes: patient medical condition information, pre-operative information, post-operative information, procedure type, operation information, anesthesia information, provider information, and/or hospital information.

The disclosed technology, in certain embodiments, includes a non-transitory computer readable medium having instructions stored thereon, wherein the instructions, when executed by a processor, cause the processor to: provide, to one or more registry users, access to a data collection marketplace, wherein: (i) the data collection marketplace includes one or more data collections associated with one or more marketplace users, (ii) each of the one or more data collections include one or more data fields identifying types of patient data for collection by each of one or more registry users that subscribe to each of the one or more data collections, and (iii) each of the one or more registry users may view the one or more data collections in the data collection marketplace; receive, from a registry user, a request for a subscription to a data collection of the one or more data collections, wherein the registry user has a standard data collection form that includes data fields that are collected by the registry user when the registry user collects patient data; responsive to subscribing to the data collection, append, to the data collection form of the registry user, one or more data fields associated with the data collection, receive, from the registry user, via a network, a patient record, wherein the patient record includes one or more data values associated with one or more data fields of the data collection; and provide, to one or more marketplace users associated with the data collection, via the data collection marketplace, access to one or more data values of the patient record associated with the one or more data fields of the data collection.

The disclosed technology, in certain embodiments, includes a method that includes receiving, via a network, from a first site, a patient record, wherein the patient record was collected by the first site; storing, by a processor of a computing device, the patient record in one or more registry databases, wherein the one or more registry databases store patient data from a plurality of sites according to a protocol specification, wherein the plurality of sites comprises the first site; determining, by the processor, that the first site is a member of one or more registry groups, wherein: (i) each registry group of the one or more registry groups comprises two or more sites of the plurality of sites, (ii) each registry group of the one or more registry groups is granted access to at least a portion of patient data provided by the two or more sites, and (iii) the patient data comprises one or more patient records; and associating, by the processor, the patient record with at least one of the one or more registry groups, wherein associating comprises making at least a portion of the patient record accessible to members of the at least one registry group.

In certain embodiments, the method includes receiving, by the processor, a request for patient data, wherein the request is associated with a second site different than the first site; determining, by the processor, the second site is a member of one or more of the at least one registry group; and providing, by the processor, to the second site, access to the patient data.

In certain embodiments, associating the patient record with the at least one registry group includes: identifying, by the processor, for each registry group of the at least one registry group, one or more fields of the patient record accessible to members of the respective registry group. In certain embodiments, the portion of the patient record accessible by members of each of the at least one registry group includes the one or more fields.

In certain embodiments, a first registry group of the one or more registry groups includes at least one of a vascular registry, an oncology registry, a national registry, and a regional registry.

In certain embodiments, the method includes receiving, by the processor, a request for a report, wherein (i) the request for the report is issued by a requesting site of the plurality of sites, and (ii) the request for the report identifies one or more search parameters, wherein the one or more search parameters include at least one member selected from the group consisting of: a) procedural information and b) one or more registry groups of which the requesting site is a member; determining, by the processor, patient data stored in the one or more registry databases satisfying the request; and providing, by the processor, to the requesting site, the patient data stored in the one or more databases satisfying the request.

In certain embodiments, the search parameters include two or more registry groups of which the requesting site is a member. In certain embodiments, each site of the plurality of sites is a hospital, research facility, doctor's office, university, insurance company, medical company, or pharmaceutical company.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a block diagram of an example system for collecting, storing, analyzing and sharing clinical and radiologic data;

FIG. 2 is block diagram of an example data registry system;

FIG. 3 is an illustration of screenshot of an example patient information screen displayed to a user;

FIG. 4 is a block diagram of an example of a data registry that allows users to pool their data within designated registry groups for analysis;

FIG. 5 is an illustration of example data records;

FIG. 6 is block diagram of an example data collection marketplace system;

FIG. 7 is an flow diagram of an example method for implementing a data collection marketplace;

FIG. 8 is an illustration of an example screenshot of a graphical user interface used to create a user and assign privileges to that user;

FIG. 9 is an illustration of an example screenshot of a graphical user interface showing an example output of an analytics and report generation module;

FIG. 10 is an illustration of a graph of percent complications as a function of the surgeon performing the procedure;

FIG. 11 is pictorial view of a graph of percentage of beta blocker use as a function of medical center;

FIG. 12 is a pictorial view of a screenshot showing a graph of the observed/expected ratio for stroke or death after CEA as a function of medical center;

FIG. 13 is a flowchart representation of an example of a process for importing patient data from a hospital electronic medical record (“EMR”) system into a data registry;

FIG. 14 shows a block diagram of an exemplary cloud computing environment; and

FIG. 15 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

FIG. 1 illustrates an example of a data registry system 10 for collecting, storing, analyzing and sharing clinical and radiologic data constructed in accordance with the disclosed technology. In some implementations, the data registry is a clinical data registry. In some implementations, data registry system 10 includes a plurality of data sites 20 (site 1 22, site 2 24 through site N 26) and a data pool 30. The plurality of data sites 20 may be hospitals, research facilities, doctors' offices, universities, insurance companies, medical or pharmaceutical companies or any other type of institution that stores data about patients. The plurality of sites 20 may also be referred to herein as “institutions”, but the sites may be any of the types of entities listed above. Each site 20 collects patient data using protocol specifications. The protocol specifications may be any specifications for the data to be collected. In some implementations, the plurality of sites 20 use the same protocol specifications. The protocol specifies how and when data is combined and how the data is reported. The patient data may be stored by the individual sites 22, 24, 26 and/or contributed to and stored in the data pool 30. In some implementations, the data is converted to a specific protocol specification. This conversion may be implemented before or after the data is stored in the data pool 30. Each site 20 may have its own patient registry that is stored separately in the data pool 30. In some implementations, the sites 20 may each develop customized data pools; however the data may still be collected according to the protocol specifications.

In some implementations, the plurality of sites 20 and the data pool 30 are connected via communications links 40, 42, 44. The communications links 40, 42, 44 may be any type of communication systems by which the plurality of sites 20 and the data pool 30 may communicate. For example, the plurality of sites 20 and the data pool 30 may communicate by a global communications network (i.e. Internet or World Wide Web), or via an intranet. In some implementations, the plurality of sites 20 may communicate with the data pool 30 using different types of communication systems. In some implementations, the plurality of sites 20 and the data pool 30 are parts of the same computer. That is, the same computer may be used to access and query the database (data pool 30) as well as store the information.

The data pool 30 may include a single data registry or multiple data registries. The data registries may be for the same medical condition or for different medical conditions. For example, there may be a vascular registry, an oncology registry, etc. All of the registries may be created using a common platform. The common platform allows users real-time access to their own data, and enables users to pool their data together as desired. In some implementations, the data pool 30 is maintained in a relational database having specified defined data fields. The data pool 30 is sorted according to protocol via site-specified front ends. The sites 20 may define the fields, reports, participants and other parameters. The centralized data pool 30 may allow for communication between different sites 20.

In some implementations, the system 10 optionally includes other entities to which data may be exported from the data pool 30 or imported to the data pool 30. For example, the system 10 may include a national registry 50, a regional registry 60, vendor sites 70 or other types of entities 80 that may wish to utilize or contribute to data stored in the data pool 30.

In some implementations, the system 10 may include an oversight group 90. An example of an oversight group 90 is a patient safety organization. In some implementations, the purpose of a patient safety organization is to enable surgeons to pool their data in an effort to improve patient care without the threat of the comparative reports being legally discoverable.

FIG. 2 is an example data registry system with one site 20 communicating with the data pool 30. In some implementations, the data registry system includes more than one site. In some implementations, system 200 includes a site 20, a first communications link 210, data security elements 220, a second communications link 230, and the data pool 30. At the site 20, a user 240 may utilize a client computer 250 to communicate with the data pool 30. The client computer 250 may be any computer or other device that is capable of executing a web browser. The client computer 250 may be one of various forms of digital computers, such as laptops, desktops, workstations, personal digital assistants, servers, blade servers, mainframes, mobile computing devices, cellular telephones, tablet computers, smart-phones, and other similar computing devices. In some implementations, the client computer 250 accesses the system using a web browser. In some implementations, the client computer 250 access the system using application-specific software. In some implementations, the user 240 uses the web browser or application specific software on the client computer 250 to access a website hosted by the data pool 30. In some implementations, a user 240 is a customer, clinician, surgeon, and/or other individual. In some implementations, the user 240 enters patient data or other data to be sent to the data pool 30. The client computer 250 may be a computer located at the site 20, or may be any other computer that has a web browser or application specific software and is connected to the Internet. As the data pool 30 is web based, surgeons or medical institutions can access the data pool 30 from any physical location.

In some implementations, the communications link 210 used by the client computer 250 to communicate with the data pool 30 is the Internet and the protocol used is a security protocol such as SSL. To increase the security of the system 200, the security elements 220 may be used. In some implementations, the security elements 220 include a first firewall 260, a proxy server 270, and/or a second firewall 280. In some implementations, other combinations of security elements that are well known in the art may be used.

In some implementations, the data pool 30 includes a registry processor 290, a primary database 292 and a backup database 294. The processor 290 may also be referred to herein as a registry application server. In some implementations, the processor 290 receives information or commands from the client computer 250 (through the communications link 210 and security elements 220) and performs operations on the data stored in the primary database 292. In some implementations, the primary database 292 and the backup database 294 are relational databases, storing information in tables. In some implementations, the primary database 292 and the backup database 294 are object-oriented databases or any other form of database capable of storing data. In some implementations, a relational database is used and the primary database 292 includes two or more tables. In some implementations, the first table is a patient information table and stores records for patient information such as the patient's personal information such as name, address, date of birth, social security number, and other personal identification information. The first table may also store information relating to the patient's medical conditions. In some implementations, the second table is a procedure table and stores records relating to medical procedures performed, such as type of procedure, pre-operative information, post-operative information, different stages of a procedure or protocol, etc.

In some implementations, the data stored in the primary database 292 is copied into the backup database 294 to help ensure that no data is lost should the primary database 292 be compromised. The backup database 294 may be at the same or different location than the primary database 292. The data in the primary database 292 may be backed-up to the backup database 294 at regular intervals or at the direction of a database administrator.

In some implementations, the system 200 is a web-based system for data collection and analysis. A user 240 may add information or perform operations on an existing registry, create a new registry, and combine clinical data from multiple existing registries. The ability to combine clinical data from multiple existing registries is due to the registries being developed on a common platform. In some implementations, different institutions or entities may be grouped together into registry groups based on common interests or geographical location. For example, two hospitals that specialize in treating vascular conditions may be grouped into a vascular registry group so that they may share data. Similarly, two hospitals that are in geographic proximity to each other may be grouped into a regional registry group so that they may share data. In some implementations, data sharing is dictated by the entities included in the group. Members of a registry group may agree to use a common format to enter and view data. However, in some implementations, the individual members of a registry group have the flexibility to add custom fields to their databases in addition to the fields that are common to all the members of the registry group. For example, one member of the registry group may want to track financial data relating to a specific procedure whereas other members are not interested in collecting that data. This custom field may be presented to or kept confidential from the other members of the group. In some implementations, when data is shared between multiple members that use different data formats, a matching algorithm may be used to identify the fields that they share and aggregate the information. Correlations can be made between data spread across registries serving disparate fields of medicine, such as oncology and cardio-vascular diseases. The cross-correlation between registries may help form causal relationships that could not be identified by the analysis of each set of data individually.

FIG. 3 shows an example screenshot 300 of a patient information screen that may be displayed to a user. In this example, the members of the registry group have decided upon certain common patient information fields 305, such as patient last name 310, patient first name 315, middle initial 320, date of birth 325, and social security number 330. The patient information screen 300 also includes procedure records 335 for the patient. In the example shown, the patient named “Testdatasharing2” had surgery on Oct. 1, 2010 consisting of three medical procedures. The procedure records 335 for the patient include fields for procedure date 340, procedure name 345, surgery side 350, surgeon 355, and visit code 360. A user may add an additional procedure for a patient by accessing the patient's record and selecting the “create new procedure” command. In some implementations, the user is then prompted to enter information for the different procedure record fields described above.

In some implementations, as described above, multiple entities storing data within the data pool 30 may be grouped into registry groups and share data with each other. FIG. 4 is a block diagram of an example of a system 400 that allows users to pool their data within designated groups for analysis. In the registry system 400 shown in FIG. 4, there are four sites, or institutions that store data in the registry system 400—site 1 405, site 2 410, site 3 415 and site 4 420. In this particular example, the sites are different medical institutions. As explained above, the sites may be any entities or individuals that store and analyze clinical data. There are two registry groups, Registry I 425 and Registry II 430. The first group Registry I 425 includes data from site 1 405, site 2 410 and site 3 415. The second group Registry II 430 includes data from site 2 410 and site 4 420. As shown in the example of FIG. 4, sites may be included in more than one registry group. This allows institutions choosing to pool their data with a specific group of hospitals at the same time to pool their data with a separate group of hospitals. There may be many layers of overlap between the registry groups. The data entered by each of the sites is available to generate aggregated data or comparative reports for registry group members on a real-time basis. However, in some implementations, the raw clinical data itself is only available to the center that entered the data, but not to any other registry group members.

Data entered into the clinical registry system is owned by the site/institution to which it is associated. Each institution specifies the data they plan to collect and with whom they want to pool data. Data entered into the system can be downloaded at any time by an institution. In some implementations, records are stored in a form where it is easy to associate and dissociate institutions and groups of institutions without compromising the integrity of data. For example, if an institution which was a part of a regional quality improvement group wished to withdraw, its data could be selectively removed from the data pool without affecting the integrity of the rest of the data.

One benefit of institutions pooling their data into registry groups is that the institutions may benchmark their results against each other. The flexibility of the registry system 400 enables a form of data harvesting that is unique from previously existing clinical registries. Data collected on multiple medical conditions may be pooled and analyzed to establish relationships between medical conditions. In addition, institutions collecting data on multiple medical conditions may reduce the data entry burden as data elements common to both medical conditions (e.g. anesthesia, diabetes status, blood pressure, antibiotic usage) may be shared without requiring redundant data entry.

FIG. 5 shows an example of patient data that has data elements common to multiple medical conditions. For example, patients John Doe and Jack D. have their names, dates of birth and anesthesia information stored in the Oncology Registry and the Vascular Registry. As described above, in some implementations, institutions do not have restrictions on the number of fields into which they can enter data.

In some implementations, another benefit of the registry system according to the disclosed technology is that it allows institutions and surgeons to longitudinally track individual patient data in real-time as it is entered, or view aggregate reports seamlessly. Procedures are associated with specific patient records and as well as surgeons. Patient records and surgeons are associated with institutions. Surgeons practicing at multiple hospitals can enter and view procedures and aggregate reports for multiple institutions using the same username and password combination. Data collected in this format can also link patients between institutions for improved longitudinal tracking of patient outcomes.

In some implementations, while the data within specific registry groups may be standardized, participating institutions can choose to support additional fields, known as customizable fields, which they use for internal purposes or for data sharing with researchers or other institutions. Referring again to FIG. 5, an example is the custom field 510. In some implementations, the registry system allows the users with appropriate privileges to create and edit customized form sections and fields that are only visible to the users in a particular institution/hospital or in a specific group of institutions/hospitals. When creating their own customized fields for data collection, the users can choose free text, drop down, numeric value, date picker, checkbox, and radio group fields that have been built into the procedure forms. After the creation of the customized field, it may be instantly available to the targeted users for data collection. In some implementations, data collected in customized fields is available for analysis in the analytics and reports, instant download and/or printing.

FIG. 6 is block diagram of an example data collection marketplace system 600. In some implementations, the system includes a data collection marketplace 604. In some implementations, the data collection marketplace 604 is a standalone system. In some implementations, the data collection marketplace 604 is integrated in a registry system. The data collection marketplace 604 may provide a venue for data providers (e.g., registry user 606) and data consumers (e.g., marketplace user 602 and/or registry user 606) to interact and further data collection efforts seamlessly. In some implementations, marketplace users 602, also referred to as publishers, can request to publish targeted data collection efforts, facilitating research, and/or compliance with regulatory mandates. The data collection marketplace 604 may provide the requested data collection in the data collection marketplace 604. In some implementations, the data collection marketplace 604 includes one or more data collections associated with one or more marketplace users. Each of the data collections may include one or more data fields identifying types of patient data for collection by each of registry users that subscribe to each of the one or more data collections.

In some implementations, as explained in more detail below, the data collection marketplace system 604 includes a data server 610, a collection manager 616, member databases 614, and/or market databases 612. In some implementations, the data collection marketplace system 604 communicates with registry users 606 and/or marketplace users 602 via a network 608. The network is a public or private network. In some implementations, the network is the Internet. In some implementations, the network is a web based network.

In some implementations, when a marketplace user 602 adds a customization to the data collection marketplace 604, the marketplace user 602 provides a synopsis or description of the data collection effort, list the number and type of additional data elements being collected, and/or disclose any conditional logic as to when the data elements are collected (e.g. male diabetics over the age of 65). In some implementations, the data collection is received by the data collection manager 616. In some implementations, the data collection manager 616 determines whether the data collection request is duplicative of other data collections already published to the data collection marketplace. If the request is duplicative, in some implementations, the collection manager 616 notifies the marketplace user 602 that the request is duplicative and does not allow the request to publish. In some implementations, the collection manager 616 publishes the duplicative request. In some implementations, if the collection manager 616 publishes the duplicative request, the data collection marketplace 604 may notify registry users that subscribe to the other data collection that is duplicative of the request that there is a new data collection that may wish to subscribe to because the data fields between the two data collections overlap.

A marketplace user 602 may also set subscription “criteria” around their publication to allow for targeted data collection. For example, a marketplace user 602 may only wish to allow for subscriptions by surgeons with certain qualifications. Some other criteria the marketplace user 602 may wish to specify are the type of hospital where data is being collected, volume of patients treated by the subscriber, outcome rate, or procedure mix. A marketplace user 602 may have the ability to limit the subscription to a certain number of subscribers or to target the subscription specific users of the system, such as specific registry users.

In some implementations, a marketplace user 602 has the option to list a subscription incentive. Many publishers may be non-users of the registry system, but have a desire or requirement to collect clinical information (e.g. the publishers/non-registry users may be clinical data consumers). For example, device manufacturers may be mandated to collect post-market surveillance information about the performance of a particular device. In this instance, the device manufacturer may offer monetary incentive for subscription to collect these additional pieces of information about device performance.

In some implementations, the data collection marketplace 604 provides the data collections for viewing by registry users 606. Registry users 606 can visit this marketplace and subscribe to data collections. Registry users may be able to browse through various customizations that have been published to the standard data collection efforts to which that particular user subscribes. In some implementations, registry users are not presented with customizations for which they do not meet the criteria specified by the publisher. In some implementations, registry users 606 are able to evaluate these customizations, understand their content and complexity, understand who the publisher is and the reason for publication, understand any incentive there may be for subscription, and ultimately subscribe to any customizations of interest. In some implementations, registry users 606 can visit the marketplace to increase the information already being collected at their institution, either through participation in ground breaking clinical research or by monetizing their existing registry subscription by aiding clinical data consumers.

In some implementations, a registry user 606 subscribes to a data collection in the marketplace. In some implementations, the registry user 606 has a standard data collection form that includes data fields that are collected by the registry user 606 when the registry user 606 collects patient data. In some implementations, the data collection marketplace 604 appends the fields associated with the data collection to which the registry user 606 subscribed to the registry users 606 data collection form. In some implementations, appending includes embedding in the registry users 606 data collection form. In some implementations, the data collection marketplace 604 includes a members database 614 that stores information regarding the data collections to which registry members have subscribed. In some implementations, the members database 614 also stores identification information relating to the data collections that have been published on the data collection marketplace 604.

In some implementations, upon subscribing to a particular data collection customization, the data elements and all conditional logic associated with the customization are immediately embedded within the registry user's 606 core data collection effort. Each time the registry user 606 initiates a core data collection effort that meets the conditions specified by the published customization, the additional data elements may appear within the standard data collection form of the registry user 606.

In some implementations, the system allows registry users 606 to customize standard data collection efforts with additional fields. In some implementations, the registry user 606 has control over where these fields are placed within a data collection effort. Furthermore, these fields can appear in line with, and can have conditional logic dependent on, standard data elements. This prevents data collection efforts from appearing complex or clustered, and only presents additional data collection elements to users when it is relevant.

As discussed above, in some implementations, registry users 606 have the opportunity to create customizations to the data collection efforts they use. In some implementations, data customizations are not limited to registry users. In some implementations, registry 606 and non-registry users, such as marketplace users 602 that are not also registry users 606, have the ability to craft a customization to standard data collection efforts, and then publish that customization to a library or marketplace.

In some implementations, the registry user 606 provides, via network 608, a patient record to the data marketplace. In some implementations, the registry user 606 provides the patient record to a registry system. In some implementations, the registry system provides the patient record to the data collection marketplace. In some implementations, the data collection marketplace access the patient record from the registry system.

In some implementations, data collection marketplace 604 includes a data server 610. The data server 610 may manage communications between the data collection marketplace 604, registry users 606, and marketplace users 602. In some implementations, the server includes market database 612 and/or members database 614. In some implementations, the market database 612 and/or members database 614 are independent of the server 610. In some implementations, the market database 612 and/or members database 614 are database 292 of FIG. 2. The market database 612 may store the data fields of the patient data provided by the registry user 606 that are responsive to data collections to which the registry user 606 subscribes.

In some implementations, the patient record includes one or more data values associated with one or more data fields of a data collection. In some implementations, the data collection marketplace culls the patient record for patient data associated with one or more data fields of a data collection. In some implementations, the data collection marketplace provides, to one or more marketplace users 602 associated with a data collection, access to one or more data values of the patient record associated with the one or more data fields of the data collection (e.g. patient data from registry users 606 who subscribed to the marketplace users 602 data collection that is associated with the data fields of the market place user's 602 data collection). Non-registry users of the data collection marketplace who publish customizations to the data collection marketplace may access the data collected through subscription to their publication in real time. In some implementations, the publisher logs into the data collection marketplace or registry system and uses the registry system analytics and reporting engine to view data entered through subscription to their publication. In some implementations, the publisher can use the analytics engine to download the data and perform off line analytics in a different system.

FIG. 7 is an flow diagram of an example method for implementing a data collection marketplace 704. In some implementations, the system includes a data collection marketplace 704. In some implementations, the data collection marketplace 704 is a standalone system. In some implementations, the data collection marketplace 704 is integrated in a clinical registry system. The data collection marketplace 704 may provide a venue for clinical data providers (e.g., registry user 706) and clinical data consumers (e.g., marketplace user 702 and/or registry user 706) to interact and further data collection efforts seamlessly. In some implementations, marketplace users 702, also referred to as publishers, can request to publish targeted data collection efforts, facilitating research, and/or compliance with regulatory mandates (708). In some implementations, the request for data collection includes a description of the data collection effort and a list of the number and/or type of data elements associated with the data collection.

The data collection marketplace 704 may provide the requested data collection in the data collection marketplace (710). In some implementations, the data collection marketplace includes one or more data collections associated with one or more marketplace users. Each of the data collections may include one or more data fields identifying types of patient data for collection by each of registry users that subscribe to each of the one or more data collections.

In some implementations, when a marketplace user 702 adds a customization to the data collection marketplace 704, the marketplace user 702 provides a synopsis or description of the data collection effort, list the number and type of additional data elements being collected, and/or disclose any conditional logic as to when the data elements are collected (e.g. male diabetics over the age of 75).

A marketplace user 702 may also set subscription “criteria” around their publication to allow for targeted data collection. For example, a marketplace user 702 may only wish to allow for subscriptions by surgeons with certain qualifications. Some other criteria the marketplace user 702 may wish to specify are the type of hospital where data is being collected, volume of patients treated by the subscriber, outcome rate, or procedure mix. A marketplace user 702 may have the ability to limit the subscription to a certain number of subscribers or to target the subscription specific users of the system, such as specific registry users.

In some implementations, a marketplace user 702 has the option to list a subscription incentive. Many publishers may be non-users of the registry system, but have a desire or requirement to collect clinical information (e.g. the publishers/non-registry users may be clinical data consumers). For example, device manufacturers may be mandated to collect post-market surveillance information about the performance of a particular device. In this instance, the device manufacturer may offer monetary incentive for subscription to collect these additional pieces of information about device performance.

In some implementations, the data collection marketplace 704 provides the data collections for viewing (712) by registry users 706. Registry users 706 can visit this marketplace and subscribe to data collections. Registry users 704 may be able to browse through various customizations that have been published to the standard data collection efforts to which that particular user subscribes. In some implementations, registry users are not presented with customizations for which they do not meet the criteria specified by the publisher. In some implementations, registry users 706 are able to evaluate these customizations, understand their content and complexity, understand who the publisher is and the reason for publication, understand any incentive there may be for subscription, and ultimately subscribe to any customizations of interest. In some implementations, registry users 706 can visit the marketplace to increase the information already being collected at their institution, either through participation in ground breaking clinical research or by monetizing their existing registry subscription by aiding clinical data consumers.

In some implementations, a registry user 706 subscribes (714) to a data collection in the marketplace 704. In some implementations, the registry user 706 has a standard data collection form that includes data fields that are collected by the registry user 706 when the registry user 706 collects patient data. In some implementations, the data collection marketplace 704 appends the fields associated with the data collection to which the registry user 706 subscribed to the registry users 706 data collection form (716). In some implementations, appending includes embedding in the registry users 706 data collection form (716).

In some implementations, upon subscribing to a particular data collection customization, the data elements and all conditional logic associated with the customization are immediately embedded within the registry user's 706 core data collection effort. Each time the registry user 706 initiates a core data collection effort that meets the conditions specified by the published customization, the additional data elements may appear within the standard data collection form of the registry user 706.

In some implementations, the system allows registry users 706 to customize standard data collection efforts with additional fields. In some implementations, the registry user 706 has control over where these fields are placed within a data collection effort. Furthermore, these fields can appear in line with, and can have conditional logic dependent on, standard data elements. This prevents data collection efforts from appearing complex or clustered, and only presents additional data collection elements to users when it is relevant.

As discussed above, in some implementations, registry users 706 have the opportunity to create customizations to the data collection efforts they use. In some implementations, data customizations are not limited to registry users. In some implementations, registry 706 and non-registry users, such as marketplace users 702 that are not also registry users 706, have the ability to craft a customization to standard data collection efforts, and then publish that customization to a library or marketplace 704.

In some implementations, the registry user 706 provides, via a network, a patient record to the data marketplace 704 (718). In some implementations, the registry user 706 provides the patient record to a registry system. In some implementations, the registry system provides the patient record to the data collection marketplace 704. In some implementations, the data collection marketplace 704 access the patient record from the registry system.

In some implementations, the patient record includes one or more data values associated with one or more data fields of a data collection. In some implementations, the data collection marketplace 704 culls the patient record for patient data associated with one or more data fields of a data collection (720). In some implementations, the data collection marketplace 704 provides, to one or more marketplace users 702 associated with a data collection, access to one or more data values of the patient record associated with the one or more data fields of the data collection (722) (e.g. patient data from registry users 706 who subscribed to the marketplace users 702 data collection that is associated with the data fields of the market place user's 702 data collection). Non-registry users of the data collection marketplace 704 who publish customizations to the data collection marketplace may access the data collected through subscription to their publication in real time. In some implementations, the publisher logs into the data collection marketplace 704 or registry system and uses the registry system analytics and reporting engine to view data entered through subscription to their publication. In some implementations, the publisher can use the analytics engine to download the data and perform off line analytics in a different system.

In some implementations of the registry system, users with appropriate privileges may design a workflow for a specific site for data entry. The user who completes his/her portion of work can assign the rest of the work to another user. After the assignment, the work may automatically appear on the assignee's work list and at the same time an email notification may be sent to the assignee.

In some implementations of the data registry, radiographic images and image measurements are integrated into the clinical data records. This feature provides a uniquely comprehensive outcomes analysis tool. Users can upload pre-operative and post-operative 2-D and 3-D images directly into data registry for web-based viewing and analysis. Images are associated with patients and their clinical data. Pre-operative and post-operative images can be easily compared side-by-side for improved outcomes tracking at the individual patient-level. Measurements from these images and changes in measurements across time are populated into the clinical data and may be made available for comparative reporting as directed by the institution. Analysis of potential associations between risk factors and patient outcomes are made easier through using a single data repository for both clinical and radiologic data.

In some implementations, the data registry may include a privilege assignment module that assigns privileges to different types of users. Roles may be associated with specific innate permissions but may also be customized by each institution to meet their specific requirements. For example, assigning the role of surgeon indicates that the user should be added to a specific drop down menu; this innate permission is the same at all institutions. Nevertheless, a user with the role of surgeon may have different access to patient data dependent upon the institution. The adaptability of the permission module allows institutions to customize their users' access to the data maintained in and available through the data registry.

FIG. 8 shows an example of a screenshot 800 of a data entry page used to create a user and assign privileges to that user. The page includes fields for username 805, password 810, first name 815, middle initial 820, last name 825, email address 830, status 835 (active/inactive), registry groups to which the user belongs 840, and the privileges 845 that the user has. The user may be assigned a role 850, such as administrator, hospital manager, surgeon, etc., and may be granted different privileges.

Data entered into the clinical registry system is made available to the institutions in real-time for the purpose of analytics and reporting. The analytics and reporting engine allows users to build their own queries for the purpose of investigating trends appearing in their own data. As shown in FIG. 9, this feature allows users to select columns 905, create filters 910, change the sort order 915, add controlled breaks 920, highlight rows/columns/cells 925, create computations 930, create aggregations 935, plot analysis result in charts 940, save report settings 945 and download data 950 for further analysis.

Users may choose a subset of data fields of interest or all fields with which to work. The analytics and reporting engine allows users to apply multiple filters 910 to the data to view possible associations between data fields. These associations may be presented in a number of different chart formats and all graphs may be saved for future reference. Data may also be presented in a tabular report. In this format, a surgeon can see how he/she performs on a specific measure as compared with an average of other surgeons participating in the same group or a hospital can see how it compares against the average of other participating hospitals.

Identified data is made available to the institution with which it is associated in the analytics and reporting engine. For institutions choosing to pool data with other institutions, de-identified data from all the participating institutions is made available for analytics and reporting engine. The purpose of the analytics and reports is to identify possible trends emerging from the data that are worthy of further statistical analysis.

For institutions choosing to pool data with other institutions, the data registry makes possible the generation of comparative data reports in real time. Through the set-up of the institutions in the database, the data from institutions choosing to share data becomes available for inclusion in reports as soon as it is entered as a completed record into the database. When a user from one of the registry groups enters a query to obtain a comparative report, the database analyzes all of the pooled data and then creates a comparative or benchmarked report which instantly appears on the user's computer screen. In some implementations, the data registry includes a number of standard queries that are designed to permit users to generate benchmarked reports based on data entered into the system in real-time. Benchmarked reports provide real-time feedback to surgeons and centers as they allow surgeons and centers to compare their performance with that of a defined group of peers (registry group) on pre-determined quality measures.

FIG. 10 is an example of a benchmark report 1010 on the surgeon level and FIG. 11 is an example of a benchmark report on a center-level. The graph 1010 of FIG. 10 plots percent complications 1015 as a function of the surgeon 1020 performing the procedure shown. Each of the numbers in the x-axis represents a different surgeon. For example, the surgeon assigned number 12 has approximately a 40 percent patient complication rate. If the user is a surgeon, he/she may identify himself/herself by their annualized rate of procedure rank. As this number is dynamic and changes depending on the annual procedure volume of the surgeons, it maintains physicians' anonymity but allows them to benchmark against other individuals at their institution. Depending on the report privilege the user is given, the report may be blinded differently. The graph 1100 of FIG. 11 plots percent use of beta blocker 1115 as a function of medical center 1120 and year 1125. For example, the medical center assigned number 11, had approximately an 98% use of beta blockers in 2003-2008, an 90% use of beta blockers in 2009 and a 65% use of beta blockers in 2010. In some implementations of the data registry, the user only sees the initials of the center name that he/she is associated with when running the report. One user can be associated with multiple centers, but he/she may be forced to choose one center before the report can run. So, the initials displayed on the report should only be the one of the center that the user chooses before running the report.

For institutions choosing to pool data with other institutions and join a registry group, the data registry also makes possible the tracking of a center's performance against that of a chosen group of institutions over time. Often, the chosen group of institutions is a regional group that is institutions located in the same geographic region. These reports show how a center compares to the Regional Group on several pre-determined quality metrics over a specified period of time. These quality metrics are established by the Regional Group as being important determinants of the quality of patient care and/or patient outcomes. Regional Groups may also set goals for performance of specific quality metrics which can be displayed on the report. Tracking of an individual center's performance as well as a Regional Group's performance on a specific quality metric can be used to demonstrate changes in clinical practice which may be analyzed for associations with changes in patient outcomes. As an example, the graph 1210 of FIG. 12 plots the observed/expected ratio for stroke or death after CEA 1215 as a function of medical center 1220.

In some implementations the data registry is able to integrate with existing hospital database systems. In some implementations, the data registry system is able to communicate with the hospital system and extract data from the hospital system. This data is then analyzed, validated, and added to the registry. For example, a hospital may use multiple data collection terminals. Patients enter their details at a patient terminal before operations are performed on them. The hospital secretary adds additional pre-operative information to the patient form and it is stored on that workstation. Within the operating room, a separate feed keeps track of the patient's vital signs and automatically uploads it to a data repository. The surgeon adds additional information to the form such as measurements, heart rate and complications. This information is combined and stored at the OR terminal. Towards the end of the procedure, billing and documentation information is stored on a workstation that's physically separated from the previous two terminals. The data from all of these terminals may be imported into the data registry system. In some implementations, this data is passed through multiple levels of constraint checks and reorganized to obtain usable data that can be inserted into the database and used to generate reports.

FIG. 13 is a flowchart 1300 representation of an example of a process for importing patient data from a hospital system into a data registry. The data registry has the ability to integrate with external hospital EMR systems and automatically pull data from them. By integrating with EMR systems, there can be a bi-directional data flow to and from the data registry database. This reduces the need for hospital data entry clerks to reenter the same data multiple times at different locations in the database. Also, it eliminates problems of inconsistencies in the data where one location contains data that is more recent than another location.

In some implementations, the system links up with the national social security death index, and matches patients in data registry database with patients listed in the national social security death index. If there is a discrepancy on the living status of a matched patient, the data registry updates the patient record with the information obtained from the national social security death index.

As shown in FIG. 14, an implementation of a network environment 1400 for use in a data registry system is shown and described. In brief overview, referring now to FIG. 14, a block diagram of an exemplary cloud computing environment 1400 is shown and described. The cloud computing environment 1400 may include one or more resource providers 1402a, 1402b, 1402c (collectively, 1402). Each resource provider 1402 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 1402 may be connected to any other resource provider 1402 in the cloud computing environment 1400. In some implementations, the resource providers 1402 may be connected over a computer network 1408. Each resource provider 1402 may be connected to one or more computing device 1404a, 1404b, 1404c (collectively, 1404), over the computer network 1408.

The cloud computing environment 1400 may include a resource manager 1406. The resource manager 1406 may be connected to the resource providers 1402 and the computing devices 1404 over the computer network 1408. In some implementations, the resource manager 1406 may facilitate the provision of computing resources by one or more resource providers 1402 to one or more computing devices 1404. The resource manager 1406 may receive a request for a computing resource from a particular computing device 1404. The resource manager 1406 may identify one or more resource providers 1402 capable of providing the computing resource requested by the computing device 1404. The resource manager 1406 may select a resource provider 1402 to provide the computing resource. The resource manager 1406 may facilitate a connection between the resource provider 1402 and a particular computing device 1404. In some implementations, the resource manager 1406 may establish a connection between a particular resource provider 1402 and a particular computing device 1404. In some implementations, the resource manager 1406 may redirect a particular computing device 1404 to a particular resource provider 1402 with the requested computing resource.

FIG. 15 shows an example of a computing device 1500 and a mobile computing device 1550 that can be used to implement the techniques described in this disclosure. The computing device 1500 is intended to represent various forms of digital computers, such as laptops, desktops, workstations, personal digital assistants, servers, blade servers, mainframes, and other appropriate computers. The mobile computing device 1550 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1500 includes a processor 1502, a memory 1504, a storage device 1506, a high-speed interface 1508 connecting to the memory 1504 and multiple high-speed expansion ports 1510, and a low-speed interface 1512 connecting to a low-speed expansion port 1514 and the storage device 1506. Each of the processor 1502, the memory 1504, the storage device 1506, the high-speed interface 1508, the high-speed expansion ports 1510, and the low-speed interface 1512, are interconnected using various busses, and may be mounted on a common motherboard or in other manners as appropriate. The processor 1502 can process instructions for execution within the computing device 1500, including instructions stored in the memory 1504 or on the storage device 1506 to display graphical information for a GUI on an external input/output device, such as a display 1516 coupled to the high-speed interface 1508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1504 stores information within the computing device 1500. In some implementations, the memory 1504 is a volatile memory unit or units. In some implementations, the memory 1504 is a non-volatile memory unit or units. The memory 1504 may also be another form of computer-readable medium, such as a magnetic or optical disk.

The storage device 1506 is capable of providing mass storage for the computing device 1500. In some implementations, the storage device 1506 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1502), perform one or more methods, such as those described above. The instructions can also be stored by one or more storage devices such as computer- or machine-readable mediums (for example, the memory 1504, the storage device 1506, or memory on the processor 1502).

The high-speed interface 1508 manages bandwidth-intensive operations for the computing device 1500, while the low-speed interface 1512 manages lower bandwidth-intensive operations. Such allocation of functions is an example only. In some implementations, the high-speed interface 1508 is coupled to the memory 1504, the display 1516 (e.g., through a graphics processor or accelerator), and to the high-speed expansion ports 1510, which may accept various expansion cards (not shown). In the implementation, the low-speed interface 1512 is coupled to the storage device 1506 and the low-speed expansion port 1514. The low-speed expansion port 1514, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 1500 may be implemented in a number of different forms, as shown in the figure. For example, it may be implemented as a standard server 1520, or multiple times in a group of such servers. In addition, it may be implemented in a personal computer such as a laptop computer 1522. It may also be implemented as part of a rack server system 1524. Alternatively, components from the computing device 1500 may be combined with other components in a mobile device (not shown), such as a mobile computing device 1550. Each of such devices may contain one or more of the computing device 1500 and the mobile computing device 1550, and an entire system may be made up of multiple computing devices communicating with each other.

The mobile computing device 1550 includes a processor 1552, a memory 1564, an input/output device such as a display 1554, a communication interface 1566, and a transceiver 1568, among other components. The mobile computing device 1550 may also be provided with a storage device, such as a micro-drive or other device, to provide additional storage. Each of the processor 1552, the memory 1564, the display 1554, the communication interface 1566, and the transceiver 1568, are interconnected using various buses, and several of the components may be mounted on a common motherboard or in other manners as appropriate.

The processor 1552 can execute instructions within the mobile computing device 1550, including instructions stored in the memory 1564. The processor 1552 may be implemented as a chipset of chips that include separate and multiple analog and digital processors. The processor 1552 may provide, for example, for coordination of the other components of the mobile computing device 1550, such as control of user interfaces, applications run by the mobile computing device 1550, and wireless communication by the mobile computing device 1550.

The processor 1552 may communicate with a user through a control interface 1558 and a display interface 1556 coupled to the display 1554. The display 1554 may be, for example, a TFT (Thin-Film-Transistor Liquid Crystal Display) display or an OLED (Organic Light Emitting Diode) display, or other appropriate display technology. The display interface 1556 may comprise appropriate circuitry for driving the display 1554 to present graphical and other information to a user. The control interface 1558 may receive commands from a user and convert them for submission to the processor 1552. In addition, an external interface 1562 may provide communication with the processor 1552, so as to enable near area communication of the mobile computing device 1550 with other devices. The external interface 1562 may provide, for example, for wired communication in some implementations, or for wireless communication in other implementations, and multiple interfaces may also be used.

The memory 1564 stores information within the mobile computing device 1550. The memory 1564 can be implemented as one or more of a computer-readable medium or media, a volatile memory unit or units, or a non-volatile memory unit or units. An expansion memory 1574 may also be provided and connected to the mobile computing device 1550 through an expansion interface 1572, which may include, for example, a SIMM (Single In Line Memory Module) card interface. The expansion memory 1574 may provide extra storage space for the mobile computing device 1550, or may also store applications or other information for the mobile computing device 1550. Specifically, the expansion memory 1574 may include instructions to carry out or supplement the processes described above, and may include secure information also. Thus, for example, the expansion memory 1574 may be provide as a security module for the mobile computing device 1550, and may be programmed with instructions that permit secure use of the mobile computing device 1550. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 1552), perform one or more methods, such as those described above. The instructions can also be stored by one or more storage devices, such as one or more computer- or machine-readable mediums (for example, the memory 1564, the expansion memory 1574, or memory on the processor 1552). In some implementations, the instructions can be received in a propagated signal, for example, over the transceiver 1568 or the external interface 1562.

The mobile computing device 1550 may communicate wirelessly through the communication interface 1566, which may include digital signal processing circuitry where necessary. The communication interface 1566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1568 using a radio-frequency. In addition, short-range communication may occur, such as using a Bluetooth®, Wi-Fi™, or other such transceiver (not shown). In addition, a GPS (Global Positioning System) receiver module 1570 may provide additional navigation- and location-related wireless data to the mobile computing device 1550, which may be used as appropriate by applications running on the mobile computing device 1550.

The mobile computing device 1550 may also communicate audibly using an audio codec 1560, which may receive spoken information from a user and convert it to usable digital information. The audio codec 1560 may likewise generate audible sound for a user, such as through a speaker, e.g., in a handset of the mobile computing device 1550. Such sound may include sound from voice telephone calls, may include recorded sound (e.g., voice messages, music files, etc.) and may also include sound generated by applications operating on the mobile computing device 1550.

The mobile computing device 1550 may be implemented in a number of different forms, as shown in the figure. For example, it may be implemented as a cellular telephone 1580. It may also be implemented as part of a smart-phone 1582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system and method for a data registry system are provided. Having described certain implementations of methods and apparatus for supporting a data registry system, it will now become apparent to one of skill in the art that other implementations incorporating the concepts of the disclosure may be used. Therefore, the disclosure should not be limited to certain implementations, but rather should be limited only by the spirit and scope of the following claims.

Throughout the description, where apparatus and systems are described as having, including, or comprising specific components, or where processes and methods are described as having, including, or comprising specific steps, it is contemplated that, additionally, there are apparatus, and systems of the disclosed technology that consist essentially of, or consist of, the recited components, and that there are processes and methods according to the disclosed technology that consist essentially of, or consist of, the recited processing steps.

It should be understood that the order of steps or order for performing certain action is immaterial so long as the disclosed technology remains operable. Moreover, two or more steps or actions may be conducted simultaneously.

1. A system comprising:
a processor;
a memory storing instructions thereon wherein the instructions, when executed, cause the processor to:
provide, to one or more registry users, access to a data collection marketplace, wherein:
the data collection marketplace includes one or more data collections associated with one or more marketplace users,
each of the one or more data collections include one or more data fields identifying types of patient data for collection by each of one or more registry users that subscribe to each of the one or more data collections, and
each of the one or more registry users may view the one or more data collections in the data collection marketplace;
receive, from a registry user, a request for a subscription to a data collection of the one or more data collections, wherein the registry user has a standard data collection form that includes data fields that are collected by the registry user when the registry user collects patient data;
responsive to subscribing to the data collection, append, to the data collection form of the registry user, one or more data fields associated with the data collection,
receive, from the registry user, via a network, a patient record, wherein the patient record includes one or more data values associated with one or more data fields of the data collection; and
provide, to one or more marketplace users associated with the data collection, via the data collection marketplace, access to one or more data values of the patient record associated with the one or more data fields of the data collection.

2. The system of claim 1, wherein the instructions, when executed, cause the processor to:
cull, prior to providing access to one or more data values of the patient record, the one or more data values of the patient record to identify the one or more data values associated with one or more data fields of the data collection.

3. The system of claim 1, wherein the instructions, when executed, cause the processor to:
receive, via a network, from a marketplace user, a request for data collection;
store the request for data collection in one or more databases; and
provide the requested data collection in the data collection marketplace.

4. The system of claim 3, wherein the request for data collection includes at least one member selected from the group consisting of: a description of the data collection effort and a list of the number and type of data elements associated with the data collection.

5. The system of claim 1, wherein the instructions, when executed, cause the processor to:
store the patient record, received from the registry user, in one or more registry databases, wherein the one or more registry databases store patient data from a plurality of registry users according to a protocol specification.

6. The system of claim 1, wherein each of the one or more data collections further comprises one or more subscription criteria.

7. The system of claim 6, wherein the instructions, when executed, cause the processor to:
determine, prior to appending, the registry user satisfies the subscription criteria associated with the data collection.

8. The system of claim 1, wherein the registry user receives an incentive upon subscribing to the data collection.

9. The system of claim 1, wherein the one or more data fields includes at least one member selected from the group consisting of: patient medical condition information field, pre-operative information field, post-operative information field, procedure type field, operation information field, anesthesia information field, provider information field, patient health field, patient demographic information fields, and hospital information field.

10. The system of claim 1, wherein the patient record includes at least one member selected from the group consisting of: patient medical condition information, pre-operative information, post-operative information, procedure type, operation information, anesthesia information, provider information, and hospital information.

11. A method comprising:
providing, by a processor of a computing device, to one or more registry users, access to a data collection marketplace, wherein:
the data collection marketplace includes one or more data collections associated with one or more marketplace users,
each of the one or more data collections include one or more data fields identifying types of patient data for collection by each of one or more registry users that subscribe to each of the one or more data collections, and
each of the one or more registry users may view the one or more data collections in the data collection marketplace;
receiving, by the processor, from a registry user, a request for a subscription to a data collection of the one or more data collections, wherein the registry user has a standard data collection form that includes data fields that are collected by the registry user when the registry user collects patient data;
responsive to subscribing to the data collection, appending, by the processor, to the data collection form of the registry user, one or more data fields associated with the data collection,
receiving, from the registry user, via a network, a patient record, wherein the patient record includes one or more data values associated with one or more data fields of the data collection; and
providing, by the processor, to one or more marketplace users associated with the data collection, via the data collection marketplace, access to one or more data values of the patient record associated with the one or more data fields of the data collection.

12. (canceled)

13. A method comprising:
receiving, via a network, from a first site, a patient record, wherein the patient record was collected by the first site;
storing, by a processor of a computing device, the patient record in one or more registry databases, wherein the one or more registry databases store patient data from a plurality of sites according to a protocol specification, wherein the plurality of sites comprises the first site;
determining, by the processor, that the first site is a member of one or more registry groups, wherein:
each registry group of the one or more registry groups comprises two or more sites of the plurality of sites,
each registry group of the one or more registry groups is granted access to at least a portion of patient data provided by the two or more sites, and
the patient data comprises one or more patient records; and
associating, by the processor, the patient record with at least one of the one or more registry groups, wherein associating comprises making at least a portion of the patient record accessible to members of the at least one registry group.

14. The method of claim 13, comprising:
receiving, by the processor, a request for patient data, wherein the request is associated with a second site different than the first site;
determining, by the processor, the second site is a member of one or more of the at least one registry group; and
providing, by the processor, to the second site, access to the patient data.

15. The method of claim 13, wherein the patient record includes at least one member selected from the group consisting of: patient medical condition information, pre-operative information, post-operative information, procedure type, operation information, anesthesia information, provider information, and hospital information.

16. The method of claim 13, wherein associating the patient record with the at least one registry group comprises:
identifying, by the processor, for each registry group of the at least one registry group, one or more fields of the patient record accessible to members of the respective registry group;
wherein the portion of the patient record accessible by members of each of the at least one registry group includes the one or more fields.

17. The method of claim 13, wherein a first registry group of the one or more registry groups comprises at least one of a vascular registry, an oncology registry, a national registry, and a regional registry.

18. The method of claim 13, comprising:
receiving, by the processor, a request for a report, wherein
the request for the report is issued by a requesting site of the plurality of sites, and
the request for the report identifies one or more search parameters, wherein the one or more search parameters include at least one member selected from the group consisting of: a) procedural information and b) one or more registry groups of which the requesting site is a member;
determining, by the processor, patient data stored in the one or more registry databases satisfying the request; and
providing, by the processor, to the requesting site, the patient data stored in the one or more databases satisfying the request.

19. The method of claim 18, wherein the search parameters include two or more registry groups of which the requesting site is a member.

20. The method of claim 13, wherein each site of the plurality of sites is a member selected from the group consisting of hospital, research facility, doctor's office, university, insurance company, medical company, and pharmaceutical company.

21-28. (canceled)
